(19) United States
(12) Patent Application Publication
(10) Pub. No.: US 2009/0027606 A1
(43) Pub. Date: Jan. 29, 2009

(54) Liquid Crystal Display Device

(76) Inventor: Youhei Nakanishi, Nara (JP)

Correspondence Address: NIXON & VANDERHYE, PC, 901 NORTH GLEBE ROAD, 11TH FLOOR, ARLINGTON, VA, 22203, US

(21) Appl. No.: 12/224,662

(22) PCT Filed: Nov. 21, 2006
(86) PCT No.: PCT/JP2006/323159

§ 371 Date: Sep. 3, 2008

(30) Foreign Application Priority Data
Mar. 20, 2006 (JP) 2006-077790

(51) Int. Cl. G02F 1/1343

(52) U.S. Cl. 349/143

(57) ABSTRACT

There are provided areas overlapping at least parts of data bus lines (6) with an intervening insulation layer and one or more holes (3a) arranged in a longitudinal direction of pixel electrodes (3) in areas overlapping the data bus lines (6), in a vertical direction to a TFT substrate. There is also provided an electric potential difference generating section for generating an electric potential difference between the pixel electrodes (3) and the data bus lines (6). Common electrodes (7) for providing auxiliary capacitance are provided on surfaces of the pixel electrodes (3) which do not face the liquid crystal with an insulation layer intervening therebetween. The data bus lines (6) are driven separately from the common electrodes (7). Therefore, nuclei for a bend transition are effectively produced around the holes (3a). The time taken by the bend transition to spread throughout the dot from the nuclei is equal to the time taken to spread the length of the latitudinal direction of each pixel electrode. The bend transition is completed in less time.

### TECHNICAL FIELD

The present invention relates to liquid crystal display devices, in particular, to OCB (Optically Self-Compensated Birefringence) liquid crystal display devices.

### BACKGROUND ART

Liquid crystal display devices have advantages over CRTs (Cathode Ray Tubes): the LCD is thinner and lighter, operates at lower voltage, and consumes less power. The liquid crystal display device is therefore used in televisions, laptop PCs (personal computers), desktop PCs, PDAs (mobile terminals), mobile phones, and other various electronic devices. Especially, an active matrix liquid crystal display device is equipped with TFTs (Thin Film Transistors) as switching elements for respective dots and has, due to its high driving capability, boasts excellent display properties comparable to the CRT. Therefore, The active matrix liquid crystal display device is widely used in devices, such as desktop PCs and televisions, where the CRT has been dominant.

The structure of a conventional active matrix liquid crystal display device will schematically described in reference to FIG. 18, an oblique view of the structure of the major parts of a conventional liquid crystal display device. The liquid crystal display device is composed of two substrates 110a and 110b and liquid crystal 102 enclosed between the substrates 110a and 110b. One of the substrate 110a is provided with intersecting gate bus lines 105 and data bus lines 106. The individual regions separated by the gate bus lines 105 and the data bus lines 106 will be referred to as dots throughout this specification. For each dot, a pixel electrode 103 and a TFT 104 are provided on the substrate 110a. A voltage is applied to the pixel electrodes 103 via the TFT 104.

On the other substrate 110b are there provided color filters (for R, G, B; not shown) facing the pixel electrodes 103 and common electrodes 107 that is common to the dots. There are three kinds of color filters (none of them shown): red (R), green (G), and blue (B). A color filter of one of the colors is located over each dot. Three neighboring red (R), green (G), and blue (B) dots represent a pixel. A voltage is applied to the liquid crystal 102 by the pixel electrodes 103 and the common electrodes 107 to produce an image.

Throughout the following, the substrate carrying the pixel electrodes and TFTs may be called the TFT substrate, and the substrate disposed opposite the TFT substrate the opposite substrate. The construction obtained by enclosing liquid crystal between the TFT and opposite substrates will be referred to as the liquid crystal panel.

Displaying movies on liquid crystal panels, such as televisions, is now rapidly becoming prevalent. The trend has created a need to increase the response speed of the liquid crystal panel to achieve a good movie display. It is the OCB liquid crystal display element that are attracting much attention recently in these respects.

In an OCB liquid crystal display element, liquid crystal molecules are sandwiched between two substrates which have been subjected to an alignment process to give them parallel and identical alignment. A retardation plate is disposed on the surface of each substrate. A polarizer is disposed on both substrates to form crossed Nicols. The retardation plates are, for example, negative retardation plates of which the major axes show hybrid alignment. The liquid crystal molecules are splay aligned in the absence of voltage across the substrates and changes to bend alignment when a voltage more than or equal to a threshold is applied. The OCB liquid crystal display device uses the bend alignment state to produce a display.

Since the OCB liquid crystal display element produces a display using the bend state, a transition of liquid crystal molecules from splay alignment (FIG. 15) to bend alignment (FIG. 16) is essential. It is known that the splay-to-bend transition (or simply the “bend transition”) can be achieved under a sideways electric field or by using holed pixel electrodes to form nuclei for the transition to bend alignment.

Patent document 1 achieves the bend transition by applying a sideways electric field across each source electrode (data bus line) and its adjacent pixel electrode or across adjacent pixel electrodes.

Patent document 2 describes provision of regions, outside the display area of the liquid crystal display element, in which liquid crystal molecules are kept in bend state by dummy display dots or transition electrodes to prevent reverse transition causing an improper display.

Patent document 3 describes provision of a wire between adjacent pixel electrodes and application of sideways voltage across the wire and the pixel electrodes to apply a voltage greater than or equal to a threshold value needed for bend transition to liquid crystal molecules.

Patent document 4 describes some of liquid crystal molecules being maintained in a bend transition state by metal electrodes under the control of common electrodes to achieve a bend transition quickly.

Patent document 5 discloses a structure forming bend transition nuclei (transition nuclei) in an intense electric field. Specifically, in patent document 5, the pixel electrode 103 partially projects at each end toward the gate line (gate bus line) 105 so as to overlap the gate line 105. Meanwhile, the gate line 105 has a plurality of notches in the area where the line 105 overlaps the projection of the pixel electrode 103.

In the conventional liquid crystal display devices arranged as above, applying a transition voltage leads to a large electric potential difference developing in the thickness direction of the liquid crystal display element. This large electric potential difference across the liquid crystal display element causes an intense electric field around the notches. The liquid crystal display device of patent document 5 is intended to exploit the intense electric field to ensure a splay-to-bend transition, achieving a good dot display with no point defects.

Patent Document 1: Japanese Unexamined Patent Publication (Tokukai) No. 2002-207206 (published Jul. 26, 2002)
Patent Document 2: Japanese Unexamined Patent Publication (Tokukai) No. 2002-311456 (published Oct. 23, 2002)
Patent Document 3: Japanese Unexamined Patent Publication (Tokukai) No. 2002-350902 (published Dec. 4, 2002)
Patent Document 4: Japanese Unexamined Patent Publication (Tokukai) No. 2005-31680 (published Feb. 3, 2005)
Patent Document 5: Japanese Patent 3334714 (registered Aug. 2, 2002; published Apr. 9, 2003), equivalent to U.S. Pat. No. 6,603,525 (issued Aug. 5, 2003; application published Aug. 8, 2002)

### DISCLOSURE OF INVENTION

Various structures have been proposed to form transition nuclei. Patent documents 1 to ˜5 are some of such examples. The time taken to achieve a bend transition throughout the individual dots is, however, not sufficiently short. Further reductions in the time are needed.

In a conventional liquid crystal display element discussed above, a transition nucleus develops at limited sites, that is, midway between the sides of the dot or near the gate bus line. It takes time for the bend alignment to spread throughout the entire dot from the transition nucleus. The present invention has an objective of reducing the time taken by the liquid crystal in the entire dot to change from splay alignment to bend alignment.

A liquid crystal display device, to address the problems, includes a first substrate, a second substrate disposed opposite the first substrate, and a liquid crystal enclosed between the first substrate and the second substrate. The first substrate includes a matrix of substantially rectangular pixel electrodes and first electrodes each extending parallel to a long side of a pixel electrode. Each pixel electrode is disposed between the liquid crystal and a first electrode and has one or more openings arranged in a longitudinal direction of that pixel electrode in areas where the pixel electrode overlaps at least parts of the first electrode with an insulation layer intervening therebetween in a direction vertical to the first substrate and in areas where the pixel electrode overlaps the first electrode in the direction vertical to the first substrate. The device includes an electric potential difference generating section for generating an electric potential difference between the pixel electrodes and the first electrodes. The device includes common electrodes, disposed on surfaces of the pixel electrodes opposite surfaces of the pixel electrodes facing the liquid crystal with an insulation layer intervening therebetween, for providing auxiliary capacitance between the common electrodes and the pixel electrodes. The first electrodes are driven separately from the common electrodes. In this context, “arranged in a longitudinal direction of the pixel electrodes” means that the openings are made in a longitudinal direction of the pixel electrodes. “One opening arranged in a longitudinal direction of the pixel electrodes” means that the opening is made in a longitudinal direction of the pixel electrodes, for example, the opening is rectangular and made virtually all along a side in the longitudinal direction of the pixel electrodes.

If there are more than one opening, especially, the openings are not limited to, for example, a rectangular shape; they may be, for example, square. If the openings are square, the alignment direction of the liquid crystal molecules near the openings is less affected by the shape of the openings, which makes it easier to orient the liquid crystal molecules in the direction of separately performed alignment processing.

The openings are, preferably, provided continuously or at intervals all along the pixel electrodes in the longitudinal direction thereof. The structure further reduces the time taken by the bend alignment to spread throughout the dot from the transition nuclei.

From the viewpoint of reducing distance for the bend transition to spread, one small opening may be made at the center of each dot. This structure is however not recommendable because it could degrade display quality.

In the structure defined above, openings are provided at sites where the pixel electrodes overlap the first electrodes. Furthermore, there is provided an electric potential difference generating section for generating an electric potential difference between the pixel electrodes and the first electrodes. Therefore, dense electric lines of force with a component parallel to the substrates occur near the openings. The electric lines of force in turn form transition nuclei. In the structure, the openings are made in the longitudinal direction of the pixel electrodes. The distance the bend transition must spread across a dot is about equal to the length of the pixel electrode in the latitudinal direction. Therefore, it takes less time for the bend transition to complete throughout the dot.

Furthermore, in the structure, the first electrodes are driven separately from the common electrodes used to provide auxiliary capacitance. Therefore, the first electrodes are not fixed to the same electric potential as the common electrodes and can be set to a potential suited to the generation of a sideways electric field. As a result, the transition nuclei are more effectively formed.

### BRIEF DESCRIPTION OF DRAWINGS

FIG. 1 is a schematic plan view showing major parts of the structure of a liquid crystal display device of embodiment 1.

FIG. 2 is a cross-sectional view of the liquid crystal display device in FIG. 1 taken along line A-A′.

FIG. 3 is a schematic plan view showing major parts of the structure of a liquid crystal display device of embodiment 2.

FIG. 4 is a cross-sectional view of the liquid crystal display device in FIG. 3 taken along line B-B′.

FIG. 5 is a schematic plan view showing major parts of the structure of a liquid crystal display device of embodiment 3.

FIG. 6 is a cross-sectional view of the liquid crystal display device in FIG. 5 taken along line C-C′.

FIG. 7 is a schematic plan view showing major parts of the structure of a liquid crystal display device of embodiment 4.

FIG. 8 is a cross-sectional view of the liquid crystal display device in FIG. 7 taken along line D-D′.

FIG. 9 is a schematic plan view showing major parts of the structure of a liquid crystal display device of embodiment 5.

FIG. 10 is a cross-sectional view of the liquid crystal display device in FIG. 9 taken along line E-E′.

FIG. 11 is a schematic plan view showing major parts of the structure of a liquid crystal display device of embodiment 6.

FIG. 12 is a cross-sectional view of the liquid crystal display device in FIG. 11 taken along line F-F′.

FIG. 13 is a schematic plan view showing major parts of the structure of a liquid crystal display device of embodiment 7.

FIG. 14 is a cross-sectional view of the liquid crystal display device in FIG. 13 taken along line G-G′.

FIG. 15 is a cross-sectional view of a liquid crystal display device when liquid crystal molecules are in splay alignment state.

FIG. 16 is a cross-sectional view of a liquid crystal display device when liquid crystal molecules are in bend alignment state.

FIG. 17 is a schematic block diagram of an overall structure of a liquid crystal display device of the present embodiment.

FIG. 18 is an oblique view of major parts of the structure of a conventional liquid crystal display device.

### REFERENCE NUMERALS

1 Liquid Crystal Display Device
1a Control Circuit (Electric Potential Difference Generating Section)
1b Data Driver (Electric Potential Difference Generating Section)
1c Gate Driver (Electric Potential Difference Generating Section)
1d Common Electrode Driver (Electric Potential Difference Generating Section)
1e First Electrode Driver (Electric Potential Difference Generating Section)
2 Liquid Crystal
3 Pixel Electrode
3a Hole (Opening)
3b Contact Hole
4 TFT
5 Gate Bus Line
6 Data Bus Line
7 Common Electrode
8 Intermediate Electrode
10a TFT Substrate (First Substrate)
10b Opposite Substrate (Second Substrate)
11 Opposite Electrode
12 Insulation Layer
13 Insulation Layer
14 Insulation Layer
102 Liquid Crystal
103 Pixel Electrode
104 TFT
105 Gate Bus Line
106 Data Bus Line
107 Common Electrode
110a Substrate
110b Substrate
203 Pixel Electrode
211 Sideways Electric Field Generating Electrode
303 Pixel Electrode
311 Sideways Electric Field Generating Electrode (Third Bus Line)
403 Pixel Electrode
411 Sideways Electric Field Generating Electrode (Third And Fourth Bus Lines)
411a Contact
503 Pixel Electrode
511 Sideways Electric Field Generating Electrode (Third Bus Line)
511a Contact
603 Pixel Electrode
606 Data Bus Line (First Electrode)
703 Pixel Electrode
703e Recess
706 Data Bus Line

### BEST MODE FOR CARRYING OUT INVENTION

### Embodiment 1

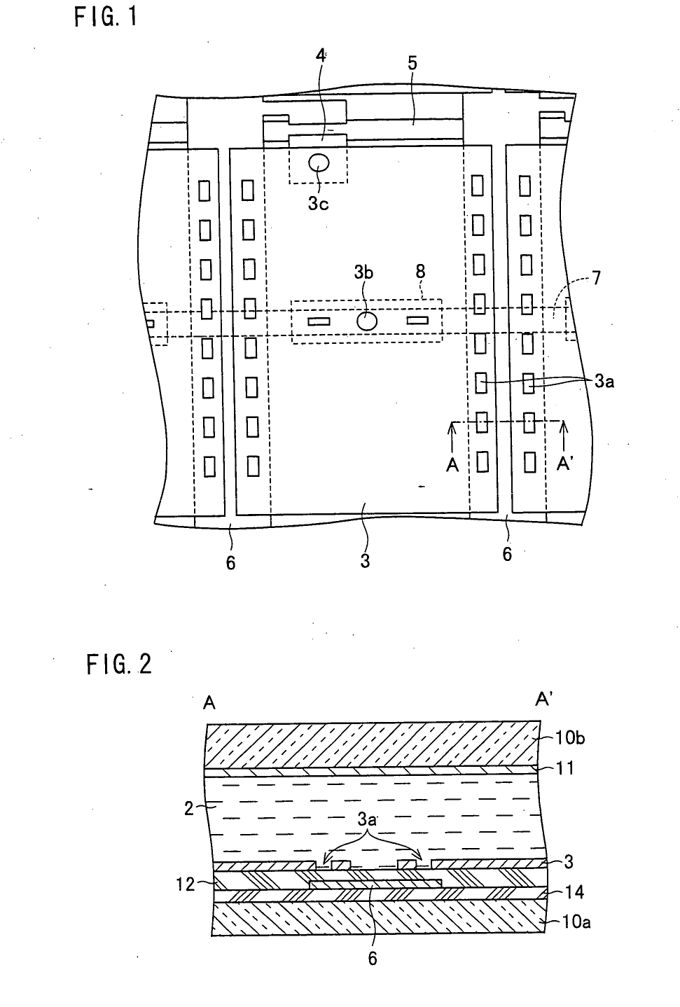

A liquid crystal display device in accordance with an embodiment of the present invention will be described in reference to FIGS. 1, 2 and 17.

FIG. 1 is a plan view showing major parts of the structure of a liquid crystal display device of the present embodiment. FIG. 2 is a cross-sectional view of the liquid crystal display device dissected along line A-A′ in FIG. 1.

Referring to FIGS. 1 and 2, the liquid crystal display device of the present embodiment includes a TFT substrate (first substrate) 10a, an opposite substrate (second substrate) 10b, a liquid crystal 2, TFTs 4, gate bus lines 5, data bus lines (first electrodes) 6, and an opposite electrode 11 (see FIG. 2). The TFTs 4 are connected to pixel electrodes 3 via contact holes 3c. These members have substantially the same structure as those used in the conventional liquid crystal display device shown in FIG. 17.

Every liquid crystal display device in this and subsequent embodiments includes the TFT substrate 10a, the opposite substrate 10b, and the liquid crystal 2 sealed between the two substrates. The opposite substrate 10b is disposed opposite the TFT substrate 10a and has formed thereon color filters (not shown) and the opposite electrode 11. The TFT substrate 10a and the opposite substrate 10b each have formed thereon a horizontal alignment film (not shown) inducing splay-alignment of the liquid crystal 2.

The TFT substrate 10a is provided with common electrodes 7 in the same layer as and parallel to the gate bus lines 5 as illustrated in FIG. 1. Intermediate electrodes 8 are disposed in the same layer as the data bus lines 6 at sites where the common electrodes 7 overlap the pixel electrodes 3. The pixel electrodes 3 and the intermediate electrodes 8 are connected via contact holes 3b. This structure creates auxiliary capacitance between the intermediate electrodes 8 and the common electrodes 7, making pixel potential stable. Next and subsequent embodiments may not explicitly mention the auxiliary capacitance, but each include the same auxiliary capacitance. The intermediate electrodes 8 may not be necessarily formed to create the auxiliary capacitance. Auxiliary capacitance can be formed between the pixel electrodes 3 and the common electrodes 7.

The pixel electrode 3 in the present embodiment is disposed so that the long sides thereof (i.e. the longitudinal sides shown in FIG. 1 extending in the top-to-bottom direction of the page, parallel to the data bus lines 6), near the edges, overlap the data bus lines 6. The pixel electrode 3 partially overlaps the data bus lines 6. Holes (openings) 3a are provided where the electrode 3 overlaps the lines 6.

FIG. 17 is a schematic block diagram of an overall structure of the liquid crystal display device of present embodiment 1. The data bus lines (first electrodes) 6, the gate bus lines 5, and the common electrodes 7 are connected to respective driver circuits shown in FIG. 17 (specifically, a data driver 1b (first electrode driver 1e), a gate driver 1c, and a common electrode driver 1d) so that the lines and electrodes 5, 6, and 7 can be individually set to any electric potential from the outside. The data driver 1b (first electrode driver 1e), the gate driver 1c, and the common electrode driver 1d are connected to and controlled by a control circuit 1a.

An electric potential difference generating section is constituted by the control circuit 1a, the data driver 1b, the gate driver 1c, the common electrode driver 1d, and the first electrode driver 1e. The electric potential difference generating section thus provided enables the creation of a potential difference between the pixel electrodes (not shown) and the first electrodes (not shown; the data bus lines in the present embodiment) and other various control operations.

The data bus lines are none other than the first electrodes in the present embodiment. Alternatively, the data bus lines and the first electrodes may be formed as different members, in which case a data bus line driver is formed separately from the first electrode driver.

The structure above (more specifically, the inclusion of the control circuit 1a, the common electrode driver 1d, and the first electrode driver 1e) enables independent driving of the first electrodes (not shown) and the common electrodes (not shown).

A high voltage is applied to the data bus lines 6 while maintaining the gate bus line 5 at such a potential that the TFT element (TFT 4) is turned off, to induce a splay-to-bend transition of the alignment of liquid crystal molecules in OCB mode. Since the TFT 4 is turned off, the potential on the data bus lines 6 is not applied to the pixel electrode 3. That enables generation of a sideways electric field between the pixel electrode 3 and the data bus lines 6. An intense electric field develops locally, which in turn forms nuclei for a bend transition.

The holes 3a in the pixel electrode 3 bend isoelectric lines in such a manner as to produce an electric field component parallel to the TFT substrate 10a and the opposite substrate 10b, thereby urging a transition from splay alignment to bend alignment. The bend transition spreads from outside the pixel electrode 3 (close to the data bus lines 6) to the midline. This mechanism of creating bend transition-inducing nuclei near the long sides of the pixel electrode 3 along the entire length of the long sides (i.e. the holes (openings) 3a in the pixel electrode 3) puts a limit on the maximum distance that the transition must spread to no more than the short side of the pixel electrode 3. That in turn reduces the time needed for the bend transition to complete.

The RGB dots are placed side by side. The sides of the pixel electrode 3 other than the long sides, that is, the short sides, are about ⅓ the length of the long side. Therefore, the mechanism of creating transition nuclei like the holes 3a along the entire length of the long sides of the pixel electrode 3 is very effective in reducing the time taken by the bend transition to spread throughout the dot.

Electrostatic capacitance could develop, causing crosstalk, between the pixel electrode 3 and the data bus lines 6 in the present embodiment. The holes 3a in the pixel electrode 3, however, reduce the area where the data bus lines 6 overlap the pixel electrode 3, contributing to restriction of the electrostatic capacitance. The thickness of an insulation layer 12 between the pixel electrode 3 and the data bus lines 6 may be reduced for further reductions in the electrostatic capacitance.

### Embodiment 2

We stated in embodiment 1 that the thickness of the insulation layer 12 between the pixel electrode 3 and the data bus lines 6 may be reduced to prevent the data bus lines 6 from forming electrostatic capacitance between the lines 6 and the pixel electrode 3 and causing crosstalk. However, the reduction in the thickness weakens the sideways electric field generated by the holes 3a in the pixel electrode 3 and the data bus lines 6. That in turn could make it difficult for the liquid crystal 2 to go through a transition to bend alignment, starting from the transition nuclei created by the sideways electric field.

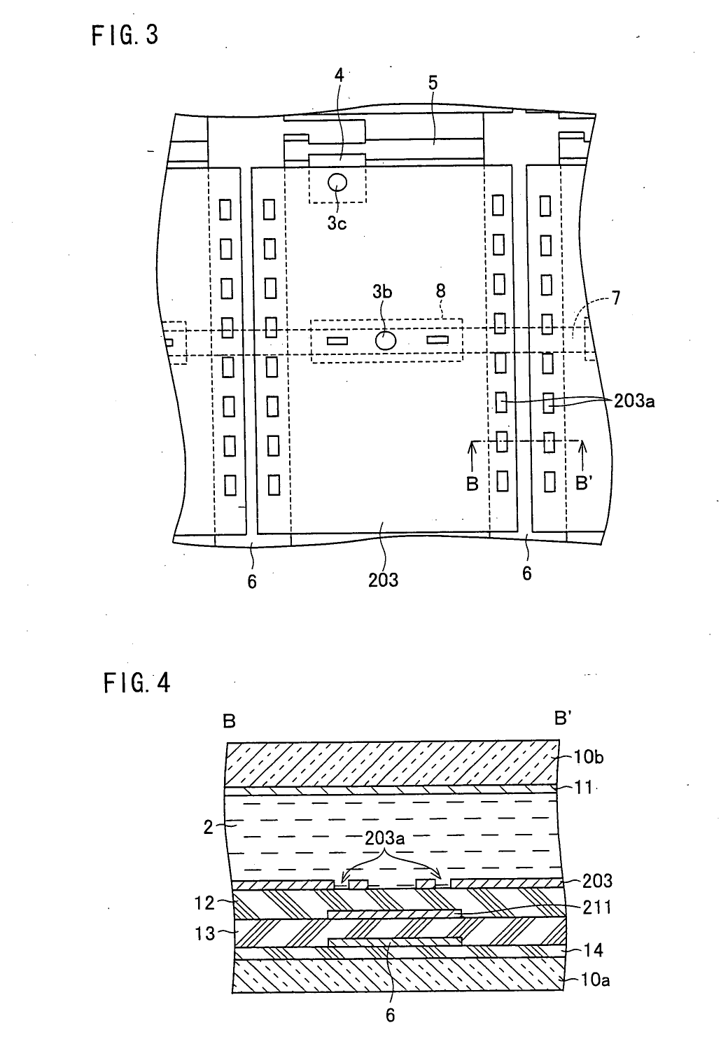

In view of these problems, the liquid crystal display device of embodiment 2 includes the construction shown in FIGS. 3 and 4. FIG. 3 is a plan view showing major parts of the structure of the liquid crystal display device of the present embodiment. FIG. 4 is a cross-sectional view of the liquid crystal display device dissected along line B-B′ in FIG. 3.

Referring to FIGS. 3 and 4, the liquid crystal display device of the present embodiment includes a sideways electric field generating electrode (third bus line) 211 on each data bus line 6 with an insulation layer 13 intervening therebetween. The electrode 211 extends parallel to the data bus line 6, or in other words, parallel to the long sides of a pixel electrode 203. The pixel electrode 203, in the present embodiment, is disposed so that the long sides thereof, near the edges, overlap the sideways electric field generating electrodes 211 with the insulation layer 12 intervening therebetween. Holes 203a are provided where the pixel electrode 203 overlap the sideways electric field generating electrodes 211.

The members of the liquid crystal display device of the present embodiment that have the same arrangement and function as members of the liquid crystal display device of embodiment 1, and that are mentioned in that embodiment may be indicated by the same reference numerals and description thereof may be omitted.

The same potential is applied to the data bus line 6 as the opposite electrode 11 (FIG. 4), and a high potential is applied to the sideways electric field generating electrodes 211, to induce a transition of liquid crystal molecules in OCB mode from splay alignment to bend alignment. A high potential that turns on the TFT 4 is preferably applied to the gate bus line 5. By doing so, the gate bus line 5 and the pixel electrode 203, although separated by a plurality of insulation layers, generate a sideways electric field between them, thereby inducing a bend transition. When the TFT 4 is turned on, if the same potential is applied to the data bus line 6 as the opposite electrode 11, an intense sideways electric field develops between the pixel electrode 203 and the sideways electric field generating electrodes 211.

Similarly to embodiment 1, the holes in the pixel electrode 203 bend isoelectric lines in such a manner as to produce an electric field component parallel to the TFT substrate 10a and the opposite substrate 10b, thereby urging a transition from splay alignment to bend alignment. The bend transition spreads from outside the pixel electrode 203 to the midline. This sideways electric field-generating mechanism installed near the long sides of the pixel electrode 203, preferably along the entire length of the long sides, puts a limit on the maximum distance that the transition must spread to no more than the short side of the pixel electrode 203. That in turn reduces the time needed for the bend transition to complete.

Nuclei for a bend transition are formed without causing crosstalk in the present embodiment as detailed above. Furthermore, the sideways electric field between the gate bus line 5 and the pixel electrode 203 is also available to induce a bend transition.

### Embodiment 3

The sideways electric field generating electrode 211 was provided over the data bus line 6 in embodiment 2. The TFT substrate 10a contained more layers than in embodiment 1, which inevitably made the manufacturing steps more complex.

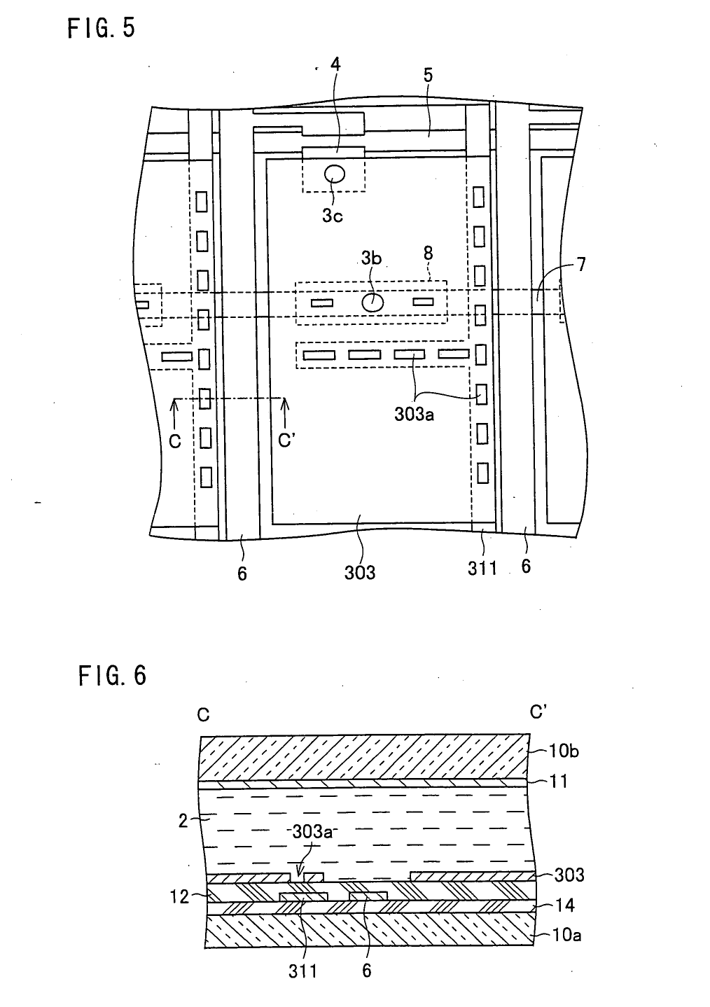

In view of the problems, the liquid crystal display device of embodiment 3 includes the construction shown in FIGS. 5 and 6. FIG. 5 is a plan view showing major parts of the structure of the liquid crystal display device of the present embodiment. FIG. 6 is a cross-sectional view of the liquid crystal display device dissected along line C-C′ in FIG. 5. The members of the liquid crystal display device of the present embodiment that have the same arrangement and function as members of the liquid crystal display device of embodiment 1 or 2, and that are mentioned in that embodiment may be indicated by the same reference numerals and description thereof may be omitted.

Referring to FIGS. 5 and 6, the liquid crystal display device of the present embodiment includes sideways electric field generating electrodes (third bus lines) 311. The electrode 311 is disposed in the same layer as and parallel to the data bus line 6, opposite the TFT 4 across the data bus line 6. In other words, the sideways electric field generating electrode 311 crosses over the gate bus line 5 with an insulation layer 14 intervening therebetween.

The sideways electric field generating electrode 311 branches out halfway across the pixel electrode 303, the branch extending parallel to the gate bus line 5 toward the midline.

The pixel electrode 303 partially overlaps the sideways electric field generating electrode 311 with the insulation layer 12 intervening therebetween. Holes 303a are provided where the pixel electrode 303 overlap the electrode 311.

The data bus lines 6, the gate bus lines 5, and the sideways electric field generating electrodes 311 are connected to respective driver circuits (not shown). The liquid crystal display device of the present embodiment includes these driver circuits and also an electric potential difference generating section which can individually set the data bus lines 6, the gate bus lines 5, and the sideways electric field generating electrodes 311 to any electric potential from the outside.

The same potential is applied to the data bus line 6 as the opposite electrode 11 (FIG. 6), and a high potential is applied to the sideways electric field generating electrode 311, to induce a transition of liquid crystal molecules in OCB mode from splay alignment to bend alignment. A high potential that turns on the TFT 4 is preferably applied to the gate bus line 5. By doing so, the gate bus line 5 and the pixel electrode 303, although separated by a plurality of insulation layers, generate a sideways electric field between them, thereby inducing a bend transition. When the TFT 4 is turned on, if the same potential is applied to the data bus line 6 as the opposite electrode 11, an intense sideways electric field develops between the pixel electrode 303 and the sideways electric field generating electrode 311.

As already discussed in embodiment 1, the holes 303a in the pixel electrode bend isoelectric lines in such a manner as to produce an electric field component parallel to the TFT substrate 10a and the opposite substrate 10b, thereby urging a transition from splay alignment to bend alignment. The bend transition spreads from outside the pixel electrode 303 to the midline. This sideways electric field-generating mechanism installed near the long sides of the pixel electrode 303, preferably along the entire length of the long sides, puts a limit on the maximum distance that the transition must spread to no more than the short side of the pixel electrode. That in turn reduces the time needed for the bend transition to complete.

The branch of the sideways electric field generating electrode 311 which extends from halfway across the pixel electrode 303 parallel to the gate bus line 5 provides an auxiliary mechanism of generating a sideways electric field, hence nuclei for a bend transition in high density, and further cutting short the distance that the bend alignment must spread. The branch may be omitted if the bend transition time poses no problem. In embodiment 2, the sideways electric field generating electrode 211 was provided on the data bus line 6 with the insulation layer 13 intervening therebetween, which added another layer to the structure and required more manufacturing steps than in embodiment 1. In contrast, the present embodiment advantageously requires no more layers than embodiment 1.

### Embodiment 4

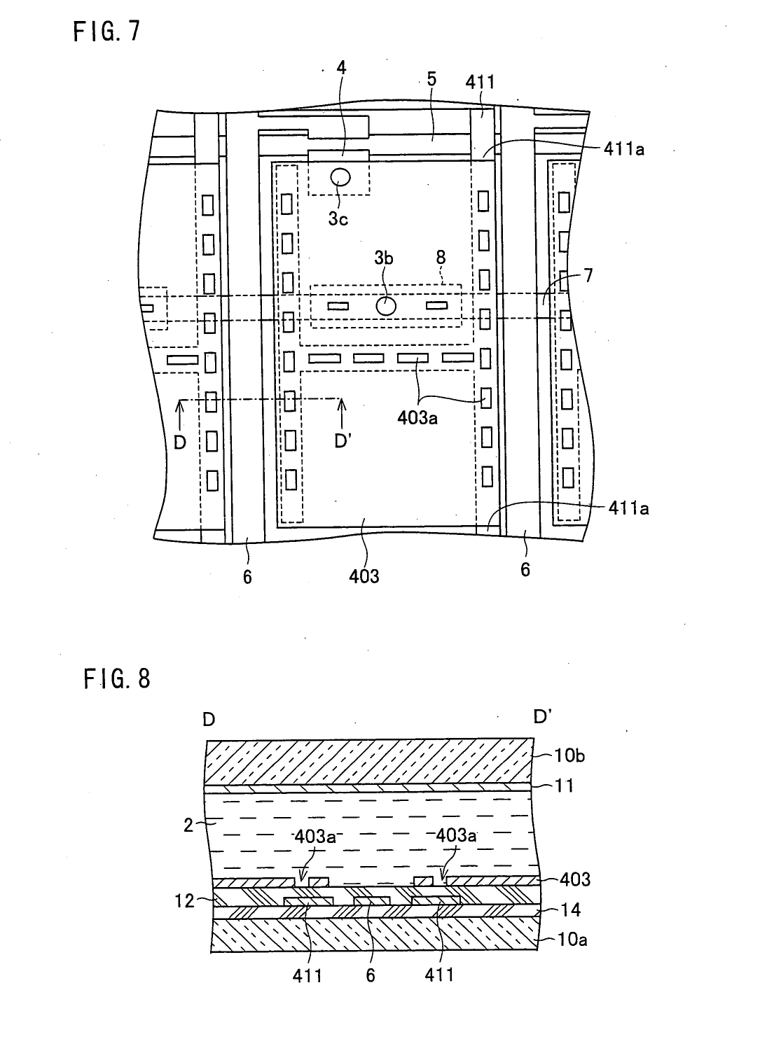

A liquid crystal display device of embodiment 4 includes the construction shown in FIGS. 7 and 8. FIG. 7 is a plan view showing major parts of the structure of the liquid crystal display device of the present embodiment. FIG. 8 is a cross-sectional view of the liquid crystal display device dissected along line D-D′ in FIG. 7.

Referring to FIGS. 7 and 8, the liquid crystal display device of the present embodiment includes sideways electric field generating electrodes (third and fourth bus lines) 411 in the same layer as the data bus lines 6. The sideways electric field generating electrode 411 forms a letter-H shape in each dot. The segments of the electrode 411 which correspond to the two vertical lines of the letter H run along the long sides of the pixel electrode 403, inside the pixel electrode 403. The pixel electrode 403, near the long sides thereof, overlaps the sideways electric field generating electrodes 411 with the insulation layer 12 intervening therebetween.

One of the segments corresponding to the two vertical lines of the letter H (opposite the TFT across the data bus line 6) is longer, and the other (on the same side of the data bus line 6 as the TFT 4) is shorter. The longer segment crosses the gate bus lines 5 with the insulation layer 14 intervening therebetween as does the data bus line 6. The shorter segment lies between adjacent gate bus lines 5. The shorter segment lies within a single dot, short of reaching the gate bus lines 5. Another segment, or branch, corresponding to the horizontal line of the letter H runs parallel to the gate bus line 5 so as to link the segments corresponding to the two vertical lines of the letter H.

Describing the structure of the sideways electric field generating electrode 411 shown in FIG. 7 from a different point of view, the pixel electrode 403 overlaps parts of the sideways electric field generating electrode 411 (for example, those except for a contact 411a). Holes 403a are provided where the pixel electrode 403 overlaps the electrode 411.

The geometry of the sideways electric field generating electrode 411 will be further described in view of the overlaps with the pixel electrode 403. The sideways electric field generating electrode 411 lies within the pixel electrode 403 except for the contact 411a, an extension connecting to an adjacent dot. No parts of the electrode 411 extend beyond the boundary of the pixel electrode 403 except for the contact 411a. In other words, the sideways electric field generating electrode 411, made from an opaque metal wire, occupies only a small area in the region surrounded by the data bus lines 6 and the gate bus lines 5. The pixel electrode 403 conversely occupies a large area in the region. The structure ensures a splay-to-bend transition in an intense electric field while restraining reductions in aperture ratio.

Where the sideways electric field generating electrode 411 extends beyond the boundary of the pixel electrode 403, a sideways electric field develops between the sideways electric field generating electrode 411 and the pixel electrode 403. For example, if the sideways electric field generating electrode 411 extends beyond the boundary of the pixel electrode 403 virtually along the entire length of a vertical side of the pixel electrode 403, the generated sideways electric field attempts to orient liquid crystal molecules in a single direction because the vertical side of the pixel electrode 403 forms a straight line stretching in that single direction. Besides, since the sideways electric field is generated virtually along the entire length of the vertical side, the sideways electric field produces a relatively strong force that could orient the liquid crystal molecules in that single direction. This strong force may in some cases orient the liquid crystal molecules against the alignment regulating force exerted by the alignment-processed liquid crystal panel. Therefore, the direction of alignment processing for the liquid crystal panel needs to be determined in view of the direction in which the sideways electric field generating electrode 411 extends beyond the boundary of the pixel electrode 403, to achieve uniform alignment of the liquid crystal molecules across the liquid crystal panel.

In the structure explained above, however, no parts of the sideways electric field generating electrode 411, except for the contact 411a, extend beyond the boundary of the pixel electrode 403. Thus there is no need to determine the direction of alignment processing for the liquid crystal panel in view of the direction in which the sideways electric field generating electrode 411 extends beyond the boundary of the pixel electrode 403. No limitations are therefore imposed on the direction of alignment processing for the liquid crystal panel. Any direction may be chosen for the alignment processing.

The sideways electric field generating electrode 411 in the structure is provided separately and driven independently from a common electrode 7 which is used to form auxiliary capacitance. Therefore, the sideways electric field generating electrode 411 is not fixed to the same electric potential as the common electrode 7. A potential suitable for the generation of a sideways electric field may be applied to the electrode 411.

The data bus lines 6, the gate bus lines 5, and the sideways electric field generating electrodes 411 are connected to and separately driven by respective driver circuits, as is the case with the data bus lines 6, the gate bus lines 5, and the sideways electric field generating electrodes 311 in embodiment 3.

The same potential is applied to the data bus line 6 as the opposite electrode 11, and a high potential is applied to the sideways electric field generating electrode 411, to induce a transition of liquid crystal molecules in OCB mode from splay alignment to bend alignment. A high potential that turns on the TFT 4 is preferably applied the gate bus line 5. By doing so, the gate bus line 5 and the pixel electrode 403, although separated by a plurality of insulation layers, generate a sideways electric field between them, thereby inducing a bend transition. When the TFT 4 is turned on, if the same potential is applied to the data bus line 6 as the opposite electrode 11, an intense sideways electric field develops between the pixel electrode 403 and the sideways electric field generating electrode 411.

The holes 403a in the pixel electrode 403 bend isoelectric lines in such a manner as to produce an electric field component parallel to the substrates (10a and 10b), thereby urging a transition from splay alignment to bend alignment. The bend transition spreads from outside the pixel electrode 403 to the inside. This sideways electric field-generating mechanism installed near the long sides of the pixel electrode 403 along the entire length of the long sides puts a limit on the maximum distance that the transition must spread to no more than half the short side of the pixel electrode 403. That in turn further reduces the time needed for the bend transition to complete than in embodiment 3.

### Embodiment 5

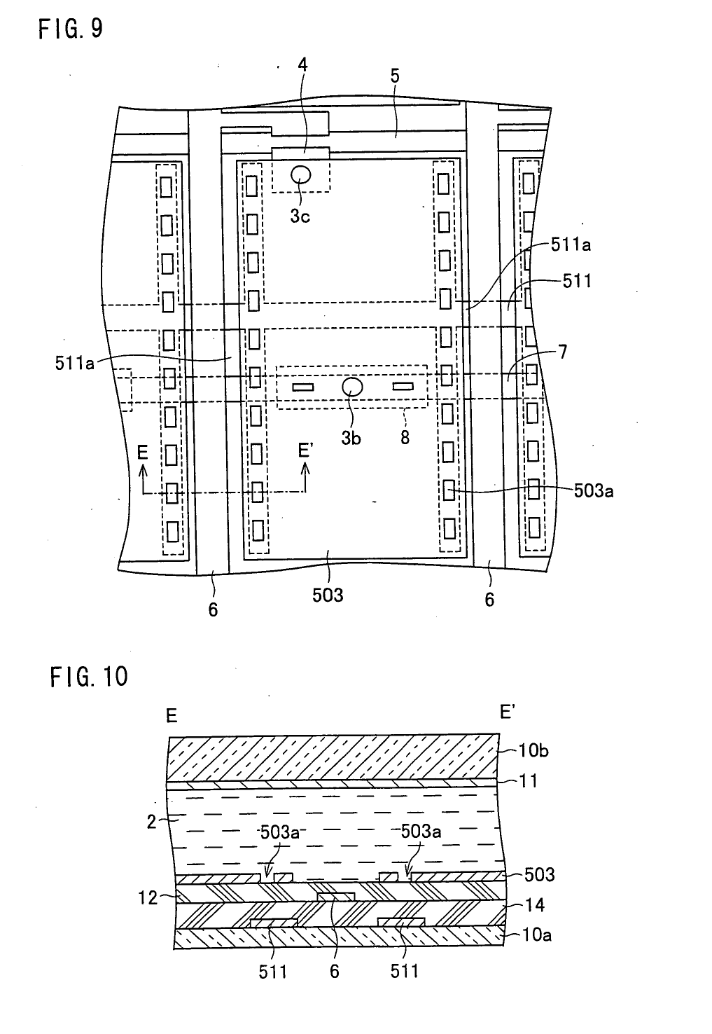

A liquid crystal display device of embodiment 5 includes the construction shown in FIGS. 9 and 10. FIG. 9 is a plan view showing major parts of the structure of the liquid crystal display device of the present embodiment. FIG. 10 is a cross-sectional view of the liquid crystal display device dissected along line E-E′ in FIG. 9.

Referring to FIG. 9, the liquid crystal display device of the present embodiment includes sideways electric field generating electrodes (third bus lines) 511 in the same layer as the gate bus lines 5. The electrodes 511, each provided near a different long side of the pixel electrodes 503, are parallel to the data bus lines 6. Each sideways electric field generating electrode 511, parallel to the data bus line 6, branches out halfway across the dot; the branches extend parallel to the gate bus lines 5 to electrically connect all the sideways electric field generating electrodes 511 running parallel to the data bus lines 6.

The liquid crystal display device of the present embodiment further includes auxiliary capacitance near the center of the dot. Intermediate electrode 8 are disposed in the same layer as the data bus lines 6 and connected respectively to pixel electrodes 503 via contact holes 3b. This structure creates auxiliary capacitance between the intermediate electrode 8 and a common electrode 7, making the potential of the pixel electrode 503 stable. The common electrode 7 is formed separately from the sideways electric field generating electrode 511.

The pixel electrode 503 in the liquid crystal display device of the present embodiment partially overlaps, near its long sides, the sideways electric field generating electrodes 511. Holes 503a are provided where the electrode 503 overlaps the electrodes 511.

The data bus lines 6, the gate bus lines 5, and the sideways electric field generating electrodes 511 are connected to and individually driven by respective driver circuits, as is the case with the data bus lines 6, the gate bus lines 5, and the sideways electric field generating electrodes 311 in embodiment 3. The sideways electric field generating electrodes 511 and the common electrodes 7 can be driven independently similarly to the embodiment above.

The same potential is applied to the data bus line 6 as the opposite electrode 11, and a high potential is applied to the sideways electric field generating electrode 511, to induce a transition of liquid crystal molecules in OCB mode from splay alignment to bend alignment. A high potential that turns on the TFT 4 is preferably applied to the gate bus line 5. By doing so, the gate bus line 5 and the pixel electrode 503, although separated by a plurality of insulation layers, generate a sideways electric field between them, thereby inducing a bend transition. When the TFT 4 is turned on, if the same potential is applied to the data bus line 6 as the opposite electrode 11, an intense sideways electric field develops between the pixel electrode 503 and the sideways electric field generating electrode 511.

The holes 503a in the pixel electrode 503 bend isoelectric lines in such a manner as to produce an electric field component parallel to the TFT substrate 10a and the opposite substrate 10b, thereby urging a transition from splay alignment to bend alignment. The liquid crystal display device of the present embodiment differs from its counterparts in embodiments 3, 4 in that the data bus lines 6 are provided in a different layer from the sideways electric field generating electrodes 511. The structure prevents short circuiting.

Similarly to the liquid crystal display device of embodiment 4, the sideways electric field generating electrode 511 in the liquid crystal display device of the present embodiment lies within the pixel electrode 503 except for a contact 511a, an extension connecting to an adjacent dot. The structure ensures a splay-to-bend transition in an intense electric field while restraining reductions in aperture ratio due to the provision of the sideways electric field generating electrode 511.

No parts of the sideways electric field generating electrode 511 extends beyond the boundary of the pixel electrode 503 except for the contact 511a. No limitations are therefore imposed on the direction of alignment processing for the liquid crystal panel. Any direction may be chosen for the alignment processing.

### Embodiment 6

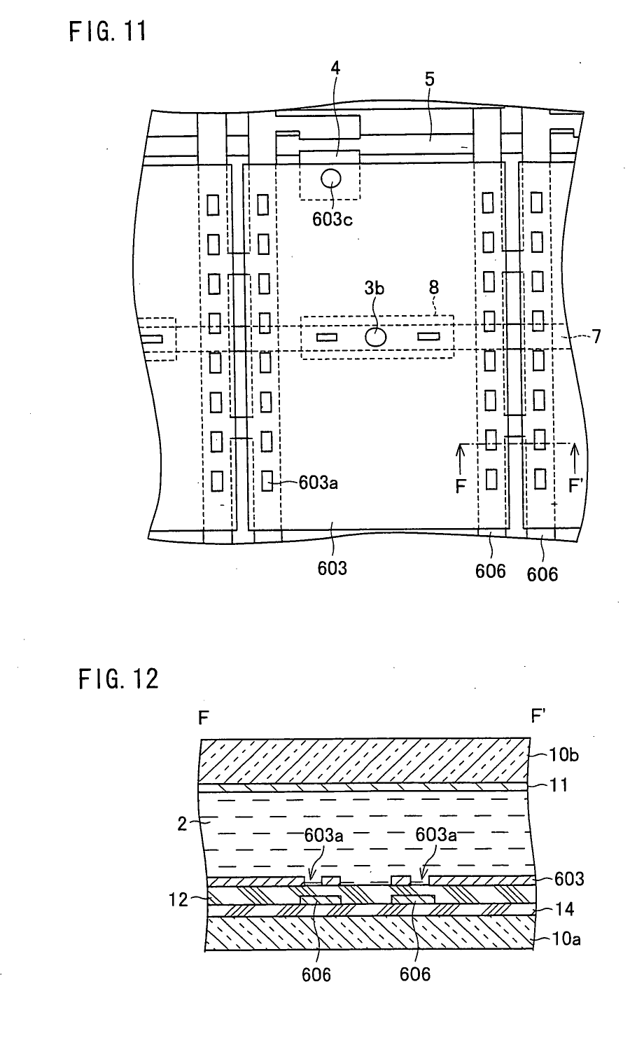

A liquid crystal display device of embodiment 6 includes the construction shown in FIGS. 11 and 12. FIG. 11 is a front view showing major parts of the structure of a liquid crystal display device of the present embodiment. FIG. 12 is a cross-sectional view of the liquid crystal display device dissected along line F-F′ in FIG. 11.

Data bus lines 606 in the present embodiment are formed like ladders so that the segments corresponding to the sidepieces (side bars) of the ladders are parallel to the long sides of pixel electrodes 603. The pixel electrode 603 is shaped so that a long side thereof and its proximity completely covers one of the sidepieces the data bus line 606. In general, the crosstalk due to the electrostatic capacitance between the pixel electrode 603 and the data bus line 606 can vary depending on the area of overlaps of the pixel electrode 603 and the data bus line 606, and the area in turn will change if the electrode 603 or the line 606 is displaced. The complete coverage of the sidepieces eliminates these problems because displacement of the electrode 603 and the line 606 does not change the overlapping area. Furthermore, an insulation layer 12, disposed between the pixel electrode 603 and the data bus line, is preferably thicker than in ordinary cases because the electrostatic capacitance between the pixel electrode 603 and the data bus line 606 should be reduced to a minimum possible level to reduce the crosstalk.

Holes 603a are provided near the long sides of the pixel electrode 603 where the electrode 603 overlaps the data bus line 606.

The data bus lines 606 and the gate bus lines 5 are connected to and individually driven by respective driver circuits.

A high potential is applied to the data bus line 606 to induce a transition of liquid crystal molecules in OCB mode from splay alignment to bend alignment. A potential that turns off the TFT 4 is preferably applied to the data bus line 606. Since the TFT 4 is turned off, when a high potential is applied to the data bus line 606, the pixel electrode 603 is maintained at substantially the same potential as the opposite electrode 11 and generates an intense sideways electric field between the pixel electrode 603 and the data bus line 606.

The holes 603a in the pixel electrode 603 bend isoelectric lines in such a manner as to produce an electric field component parallel to the substrates (10a and 10b), thereby urging a transition from splay alignment to bend alignment.

### Embodiment 7

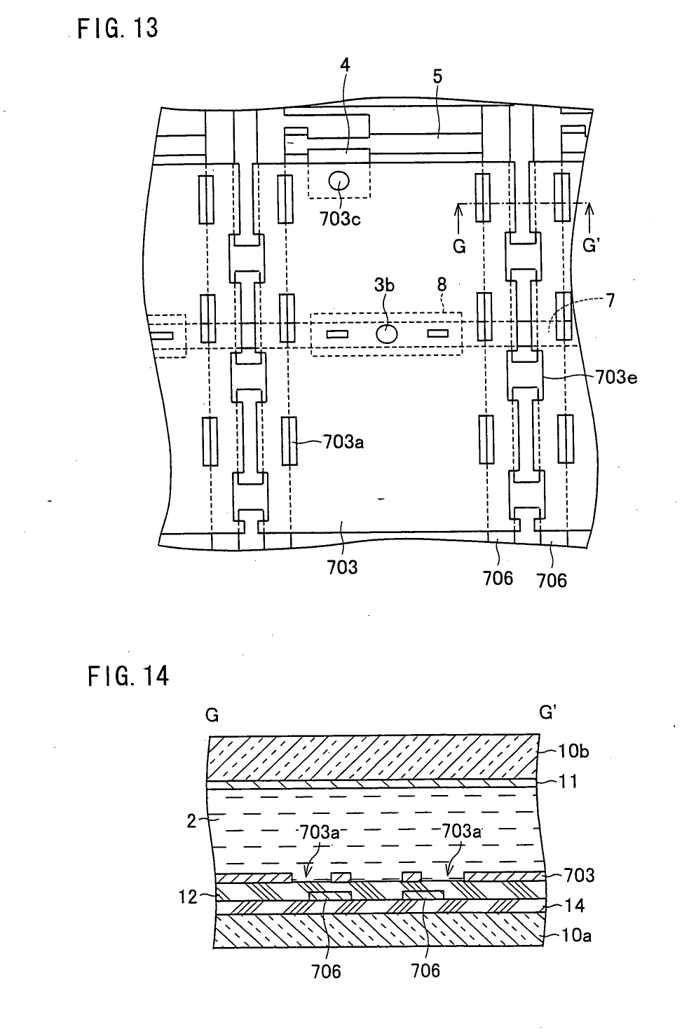

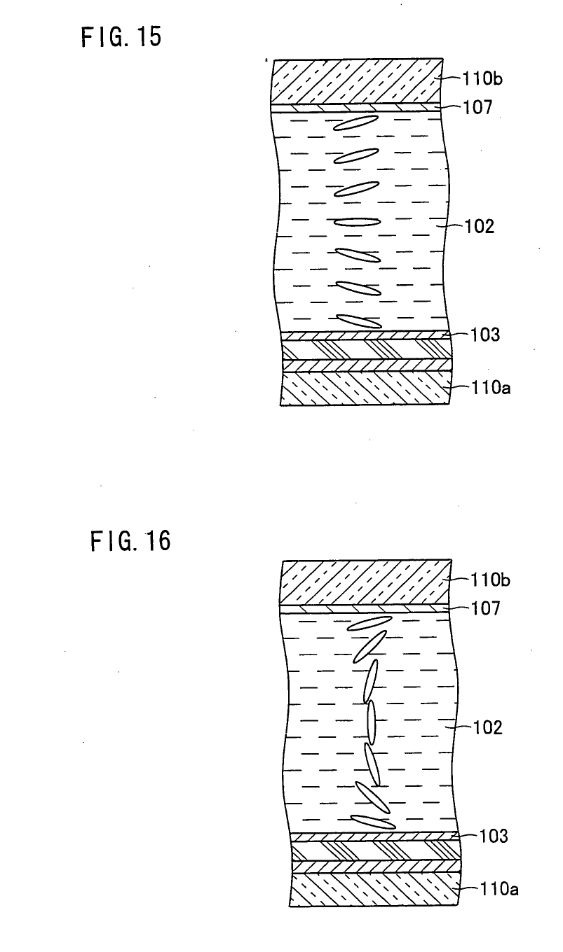

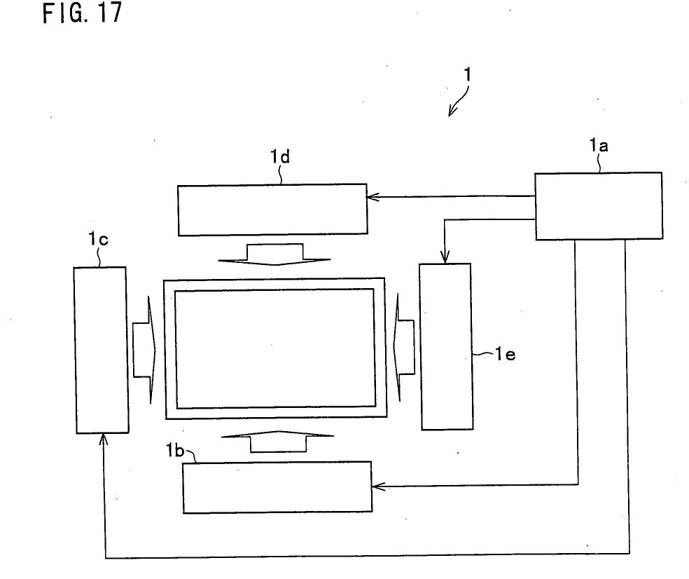

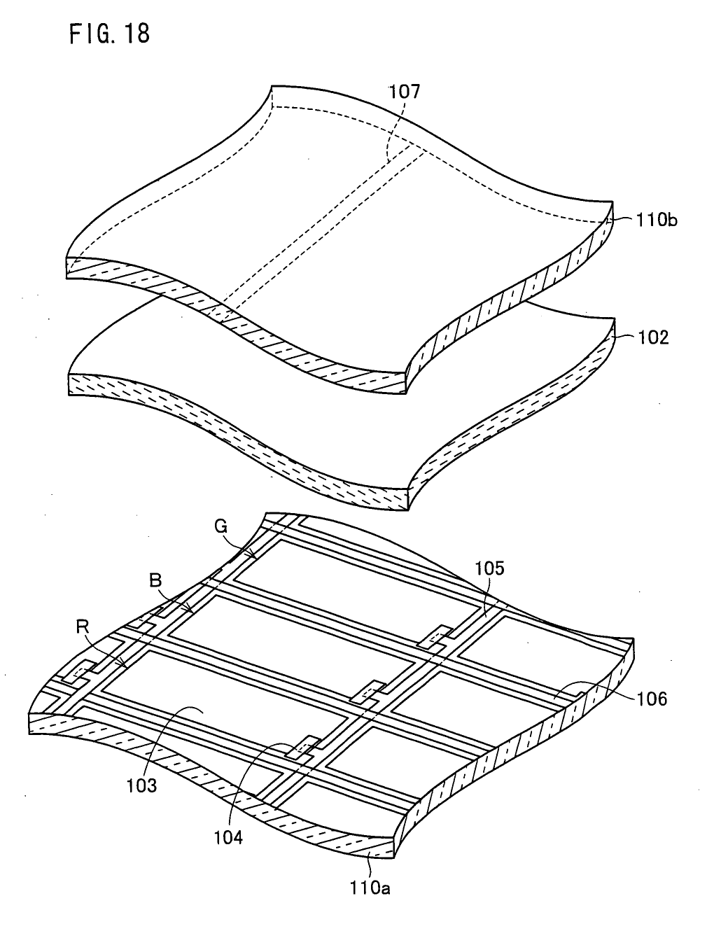

A liquid crystal display device of embodiment 7 includes the construction shown in FIGS. 13 and 14. FIG. 13 is a front view showing major parts of the structure of a liquid crystal display device of the present embodiment. FIG. 14 is a cross-sectional view of the liquid crystal display device dissected along line G-G′ in FIG. 13.

Referring to FIGS. 13 and 14, data bus lines 706 in the present embodiment are formed like ladders similarly to embodiment 6. Pixel electrodes 703 are each shaped so that a long side thereof and its proximity covers one of the sidepieces of a ladder. Near the joints of the segments corresponding to the sidepieces of the ladder and the segments connecting those sidepieces, the pixel electrode 703 has recesses 703e made toward inside the pixel electrode 703 from the edges of the long sides of the pixel electrode 703.

Holes 703a are provided in the pixel electrode 703 where the pixel electrode 703 overlaps the data bus line 706 as shown in FIG. 13. The edges of the data bus line 706 are provided inside the holes 703a in the liquid crystal display device of the present embodiment. This structure reduces changes in the area of overlaps of the pixel electrode 703 and the data bus line 706 when the pixel electrode 703 or the data bus line 706 is displaced.

Generally, the crosstalk due to the electrostatic capacitance between the pixel electrode 703 and the data bus line 706 can vary depending on the area of overlaps of the pixel electrode 703 and the data bus line 706, and the area in turn will change if the electrode 703 or the line 706 is displaced. In contrast, the liquid crystal display device of the present embodiment further reduces variations in the overlapping area, hence variations in the crosstalk, than the liquid crystal display device of embodiment 6. Furthermore, an insulation layer 12, disposed between the pixel electrode 703 and the data bus line 706, is preferably thicker than in ordinary cases because the electrostatic capacitance between the pixel electrode 703 and the data bus line 706 should be reduced to a minimum possible level to reduce the crosstalk.

The data bus lines 706 and the gate bus lines 5 are connected to and individually driven by respective driver circuits.

The same potential is applied to the data bus line 706 as the opposite electrode 11, and a high potential is applied to the data bus line 706, to induce a transition of liquid crystal molecules in OCB mode from splay alignment to bend alignment. A potential that turns off the TFT 4 is preferably applied to the gate bus line 5. Since the TFT 4 is turned off, when a high potential is applied to the data bus line 706, the pixel electrode 703 is maintained at substantially the same potential as the opposite electrode 11 and as a result, generates an intense sideways electric field between the pixel electrode 703 and the data bus line 706.

The holes 703a in the pixel electrode bend isoelectric lines in such a manner as to produce an electric field component parallel to the TFT substrate 10a and the opposite substrate 10b, thereby urging a transition from splay alignment to bend alignment.

The figures to which reference was made in the description of embodiments assume that the holes provided in the pixel electrodes to form transition nuclei are rectangular. The shape of the holes is, however, by no means limited to this specific example given in the embodiments. The shape is not limited in any particular manner and may be shaped like a letter V, L, or W, or may be rectangular to name a few examples.

The liquid crystal display device may be realized as a liquid crystal display device which includes: a first and a second substrate disposed opposite to each other; a liquid crystal enclosed between the first and the second substrate, the liquid crystal being in splay alignment when no voltage is being applied and needing to make a transition to bend alignment to produce a display; gate bus lines provided on the first substrate; data bus lines provided almost at right angles to the gate bus lines; TFTs connected to the gate bus lines and the data bus lines; pixel electrodes provided in dot regions separated by the gate bus lines and the data bus lines; and one of the following arrangements [8] to [14].

[8] A liquid crystal display device having: one or more openings near the long sides of the pixel electrodes; and a mechanism for producing an electric potential difference between the pixel electrodes and the data bus lines near the openings.
[9] A liquid crystal display device having: third bus lines overlapping the data bus lines with an insulation film (insulation layer) intervening therebetween, the long sides of the pixel electrodes proximity overlapping the third bus lines; openings at the overlaps; and a mechanism for producing an electric potential difference between the pixel electrodes and the third bus lines.
[10] A liquid crystal display device having: sideways electric field generating electrodes in the same layer as the data bus lines, parallel to the data bus lines, near at least either one of the data bus lines to the right or left of the data bus lines, the long sides of the pixel electrodes proximity overlapping the sideways electric field generating electrodes; openings in the overlaps; and a mechanism for producing an electric potential difference between the pixel electrodes and the sideways electric field generating electrodes.
[11] A liquid crystal display device having: sideways electric field generating electrodes in the same layer as the data bus lines, parallel to the data bus lines, near both sides of the data bus lines, the sideways electric field generating electrodes extending parallel to the gate bus lines at the midline of the dots, at least either one of the sideways electric field generating electrodes to the right or left of the data bus lines extending parallel to the data bus lines, the long sides of the pixel electrodes proximity overlapping the sideways electric field generating electrodes; openings in the overlaps; and a mechanism for producing an electric potential difference between the pixel electrodes and the sideways electric field generating electrodes.
[12] A liquid crystal display device having: sideways electric field generating electrodes in the same layer as the gate bus lines, parallel to the gate bus lines, the sideways electric field generating electrodes extending parallel to the data bus lines near the long sides of the pixel electrodes, the sideways electric field generating electrodes overlapping near the long sides of the pixel electrodes; openings in the pixel electrodes in the overlaps; and a mechanism for producing an electric potential difference between the pixel electrodes and the sideways electric field generating electrodes.
[13] A liquid crystal display device in which: the data bus lines are like ladders; and the pixel electrodes are formed to cover a sidepiece on one side of one of the two ladder-like data bus lines, the liquid crystal display device having: openings near the long sides of the pixel electrodes overlapping the data bus lines; and a mechanism for producing an electric potential difference between the pixel electrodes and the data bus lines.
[14] A liquid crystal display device in which: the data bus lines are like ladders; the pixel electrodes are formed to cover a sidepieces on one side of one of the two ladder-like data bus lines; and the pixel electrodes are dented with the pixel electrodes not overlapping the data bus lines in the segments, of the ladder-like data bus lines, which connect sidepieces, the liquid crystal display device having: openings near the long sides of the pixel electrodes on the sides of the data bus lines corresponding to the inside of the pixel electrodes, the length of the dents in the pixel electrodes measured parallel to the data bus lines is equal to the length of the openings of the pixel electrodes measured parallel to the data bus lines; and a mechanism for producing an electric potential difference between the pixel electrodes and the data bus lines.

Accordingly, the electrostatic capacitance provided by the data bus lines and the pixel electrodes are uniform across the liquid crystal panel. Looking at the right side of the dots here, if the dots are displaced to the right with respect to the data bus lines, the dents in the pixel electrodes move to the right, locally increasing overlapping area. However, the openings also move to the right, locally decreasing overlapping area. Therefore, if the dents and the openings have the same longitudinal length, the increases and decreases in overlapping area are cancelled out, causing no overall changes in the overlapping area. In other words, if the pixel electrodes and the data bus lines are displaced a little to the right/left, the overlapping area does not change. Photolithography is used generally to form the bus lines and the pixel electrodes. Photolithography involves a step in which light is projected through a mask on which patterns are drawn to expose photoresist. Since a plurality of layers overlap, small displacements from predetermined positions occur due to the positioning of the mask. The magnitude of the displacement varies from layer to layer. Photolithographic methods can be classified into several types. In one of them, a liquid crystal panel is divided into regions which are sequentially exposed to light. In this particular method, the magnitude of the displacement between layers varies from place to place, which could cause differences in electrostatic capacitance and a faint (nevertheless visible) tile-like pattern. However, the arrangements explained above prohibit the displacements from causing different in electrostatic capacitance, much less the tile-like pattern.

In the liquid crystal display device, as mentioned earlier, the first substrate includes a matrix of substantially rectangular pixel electrodes and first electrodes each extending parallel to a long side of a pixel electrode; each pixel electrode is disposed between the liquid crystal and a first electrode and has one or more openings arranged in a longitudinal direction of that pixel electrode in areas where the pixel electrode overlaps at least parts of the first electrode with an insulation layer intervening therebetween in a direction vertical to the first substrate and in areas where the pixel electrode overlaps the first electrode in the direction vertical to the first substrate; the device includes an electric potential difference generating section for generating an electric potential difference between the pixel electrodes and the first electrodes; the device includes common electrodes, disposed on surfaces of the pixel electrodes which do not face the liquid crystal with an insulation layer intervening therebetween, for providing auxiliary capacitance; and the first electrodes are driven separately from the common electrodes.

The arrangement includes a sideways electric field generating mechanism in a longitudinal direction of the pixel electrodes. As a result, the arrangement reduces the distance the bend transition must spread across a dot around the pixel electrodes, thus cutting the bend transition time short.

Also, in the arrangement, the first electrodes are driven separately from the common electrodes used to provided auxiliary capacitance. Therefore, when a sideways electric field is generated, the first electrodes are not fixed to the same electric potential as the common electrodes and can be set to a potential suited to the generation of a sideways electric field. The sideways electric field is generated efficiently.

The liquid crystal display device is preferably such that: the first electrodes are data bus lines; the first substrate includes gate bus lines; and the first electrodes intersect the gate bus lines at right angles and extending parallel to the longitudinal direction of the pixel electrodes.

The arrangement uses data bus lines and requires no formation of new electrodes, allowing for a device with a simple structure. The data bus lines are formed in a longitudinal direction of the pixel electrodes, which facilitates the formation of transition nuclei all along the pixel electrodes in the longitudinal direction thereof.

The liquid crystal display device is preferably such that: the first substrate includes gate bus lines and data bus lines, the data bus lines intersecting the gate bus lines at right angles and extending parallel to the longitudinal direction of the pixel electrodes; and the first electrodes are third bus lines disposed closer to the liquid crystal than are the data bus lines and with an insulation layer intervening between the first electrodes and the data bus lines in the direction vertical to the first substrate, the third bus lines extending parallel to the data bus lines.

In the arrangement, the first electrodes are separately provided from the data bus lines, enabling generation of an intense sideways electric field and reinforcing the function of causing the liquid crystal to make a transition to bend alignment.

The liquid crystal display device is preferably such that: the first substrate includes gate bus lines and data bus lines, the data bus lines intersecting the gate bus lines at right angles and extending parallel to the longitudinal direction of the pixel electrodes; and the first electrodes are third bus lines each disposed on at least one side of a data bus line in the same layer as the data bus line with respect to a surface of the first substrate so as to extend parallel to the data bus line.

In the arrangement, the first electrodes are formed in the same layer as the data bus lines. The arrangement therefore does not add to layers, making the structure of the liquid crystal display device simple.

Also in the arrangement, preferably, the third bus lines each include a branch extending parallel to a gate bus line in an area where that third bus line overlaps a pixel electrode, and the pixel electrodes each have an opening in an area where that pixel electrode overlaps a part of the third bus line extending parallel to a data bus line and in an area where the pixel electrode overlaps the branch.

The arrangement reduces the distance the bend alignment must spread, further reducing bend transition time.

The liquid crystal display device is preferably such that: the first substrate includes gate bus lines and data bus lines, the data bus lines intersecting the gate bus lines at right angles and extending parallel to the long sides of the pixel electrodes; the first electrodes include third and fourth bus lines each extending parallel to a data bus line along two opposite long sides of a pixel electrode in the same layer as that data bus line with respect to a surface of the first substrate to overlap that pixel electrode; the first electrodes each include a branch disposed parallel to a gate bus line so as to overlap the pixel electrode in a direction vertical to the first substrate and to link a third and a fourth bus line; and the pixel electrodes each have an opening at sites where that pixel electrode overlaps the third bus line, the fourth bus line, and the branch.

The arrangement reduces the distance the bend alignment must spread, further reducing bend transition time.

The liquid crystal display device is preferably such that: the first substrate includes gate bus lines and data bus lines, the data bus lines intersecting the gate bus lines at right angles and extending parallel to the long sides of the pixel electrodes; and the first electrodes are third bus lines each having, in the same layer as a gate bus line with respect to a surface of the first substrate, an area (part) extending parallel to that gate bus line over a pair of adjacent pixel electrodes and an area (part) branching off parallel to a data bus line from these areas.

In the arrangement, the first substrate has, in the same layer as each gate bus line with respect to a surface of the first substrate, an area (part) extending parallel to the gate bus line over a pair of adjacent pixel electrodes and an area (part) branching off parallel to a data bus line from these areas. The electric potential of the first electrode is therefore stable.

The liquid crystal display device is preferably such that: the first substrate includes gate bus lines and ladder-like data bus lines, the data bus lines each constituted by a pair of side bar-like lines extending vertical to a gate bus line and parallel to long sides of a pixel electrode and a rung-like line connecting the pair of side bar-like lines; the first electrodes are the data bus lines; one of the long sides of the pixel electrode is provided between a pair of side bar-like lines for a data bus line, and the other side is provided between a pair of side bar-like lines for another data bus line adjacent to the data bus line; and the pixel electrodes each have an opening at sites where that pixel electrode overlaps the side bar-like lines in a direction vertical to the first substrate.

The arrangement reduces changes in overlapping area of the pixel electrodes and the data bus lines when the pixel electrodes and the data bus lines are displaced.

The liquid crystal display device is preferably such that the pixel electrodes each have a recess made toward a center of a pixel electrode from edges of the long sides thereof; and the rung-like line is disposed in the recess.

The arrangement further reduces changes in overlapping area of the pixel electrodes and the data bus lines when the pixel electrodes and the data bus lines are displaced.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is applicable to various display devices which display characters and images using liquid crystal.

1. A liquid crystal display device comprising:
a first substrate;
a second substrate disposed opposite the first substrate; and
a liquid crystal enclosed between the first substrate and the second substrate,
the first substrate including a matrix of substantially rectangular pixel electrodes and first electrodes each extending parallel to a long side of a pixel electrode,
each pixel electrode being disposed between the liquid crystal and a first electrode and having one or more openings arranged in a longitudinal direction of that pixel electrode in areas where the pixel electrode overlaps at least parts of the first electrode with an insulation layer intervening therebetween in a direction vertical to the first substrate and in areas where the pixel electrode overlaps the first electrode in the direction vertical to the first substrate,
the device including an electric potential difference generating section for generating an electric potential difference between the pixel electrodes and the first electrodes,
the device including common electrodes, disposed on surfaces of the pixel electrodes which do not face the liquid crystal with an insulation layer intervening therebetween, for providing auxiliary capacitance,
the first electrodes being driven separately from the common electrodes.

2. The liquid crystal display device of claim 1, wherein:
the first electrodes are data bus lines;
the first substrate includes gate bus lines; and
the first electrodes intersect the gate bus lines at right angles and extending parallel to the longitudinal direction of the pixel electrodes.

3. The liquid crystal display device of claim 1, wherein:
the first substrate includes gate bus lines and data bus lines, the data bus lines intersecting the gate bus lines at right angles and extending parallel to the longitudinal direction of the pixel electrodes; and
the first electrodes are third bus lines disposed closer to the liquid crystal than are the data bus lines and with an insulation layer intervening between the first electrodes and the data bus lines in the direction vertical to the first substrate, the third bus lines extending parallel to the data bus lines.

4. The liquid crystal display device of claim 1, wherein:
the first substrate includes gate bus lines and data bus lines, the data bus lines intersecting the gate bus lines at right angles and extending parallel to the longitudinal direction of the pixel electrodes; and
the first electrodes are third bus lines each disposed on at least one side of a data bus line in the same layer as the data bus line with respect to a surface of the first substrate so as to extend parallel to the data bus line.

5. The liquid crystal display device of claim 4, wherein:
the third bus lines each include a branch extending parallel to a gate bus line in an area where that third bus line overlaps a pixel electrode; and
the pixel electrodes each have an opening in an area where that pixel electrode overlaps a part of the third bus line extending parallel to a data bus line and in an area where the pixel electrode overlaps the branch.

6. The liquid crystal display device of claim 1, wherein:
the first substrate includes gate bus lines and data bus lines, the data bus lines intersecting the gate bus lines at right angles and extending parallel to the long sides of the pixel electrodes;
the first electrodes include third and fourth bus lines each extending parallel to a data bus line along two opposite long sides of a pixel electrode in the same layer as that data bus line with respect to a surface of the first substrate to overlap that pixel electrode;
the first electrodes each include a branch disposed parallel to a gate bus line so as to overlap the pixel electrode in a direction vertical to the first substrate and to link a third and a fourth bus line; and
the pixel electrodes each have an opening at sites where that pixel electrode overlaps the third bus line, the fourth bus line, and the branch.

7. The liquid crystal display device of claim 1, wherein:
the first substrate includes gate bus lines and data bus lines, the data bus lines intersecting the gate bus lines at right angles and extending parallel to the long sides of the pixel electrodes; and
the first electrodes are third bus lines each having, in the same layer as a gate bus line with respect to a surface of the first substrate, an area extending parallel to that gate bus line over a pair of adjacent pixel electrodes and an area branching off parallel to a data bus line from these areas.

8. The liquid crystal display device of claim 1, wherein
the first substrate includes gate bus lines and ladder-like data bus lines, the data bus lines each constituted by a pair of side bar-like lines extending vertical to a gate bus line and parallel to long sides of a pixel electrode and a rung-like line connecting the pair of side bar-like lines;
the first electrodes are the data bus lines;
one of the long sides of the pixel electrode is provided between a pair of side bar-like lines for a data bus line, and the other side is provided between a pair of side bar-like lines for another data bus line adjacent to the data bus line; and
the pixel electrodes each have an opening at sites where that pixel electrode overlaps the side bar-like lines in a direction vertical to the first substrate.

9. The liquid crystal display device of claim 7, wherein
the pixel electrodes each have a recess made toward a center of a pixel electrode from edges of the long sides thereof; and
the rung-like line is disposed in the recess.
